(19) United States
(12) Patent Application Publication
(10) Pub. No.: US 2004/0208790 A1
(43) Pub. Date: Oct. 21, 2004

(54) Rotating and tapping apparatus

(75) Inventor: David Daf, Taipei (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Taigen Bioscience Corporation, Taipei (TW)

(21) Appl. No.: 10/419,458

(22) Filed: Apr. 21, 2003

(51) Int. Cl. B01L 3/00

(52) U.S. Cl. 422/99

(57) ABSTRACT

The present invention discloses a rotating and tapping apparatus that can be integrated into a program controlled workstation for removing liquid in a multi-well plate/block. The rotating and tapping apparatus includes a frame device having at least a plate holder for holding at least a multi-well plate thereon, and a driving device for proceeding a rotating and a tapping actions of the frame device to remove liquid in the multi-well plate.

### FIELD OF THE INVENTION

This invention relates to a rotating and tapping apparatus for removing liquid in a multi-well plate on a program controlled workstation.

### BACKGROUND OF THE INVENTION

The program controlled workstation is commonly used to proceed high-throughput applications with multi-well plates/blocks in labs. Various apparatuses, such as robotics with multi-channel pipets for liquid handling, shakers for mixing, and incubators for temperature-dependent reactions, etc., are combined on the program controlled workstation to perform the experiments in the multi-well plates/blocks. The so-called multi-well plates/blocks are plates or blocks divided into plural independent wells that are used frequently in chemical, biochemical, pharmacological and medical labs, such as 24-well plates/blocks, 48-well plates/blocks, 96-well plates/blocks and 384-well plates/blocks.

Magnetic beads technology is used widely in biotechnology. Generally, the magnetic bead is made of Fe₃O₄ or r-Fe₂O₃, and has a various diameter, commonly 10 nm. After proper treatments, the magnetic beads can be used in different applications. For example, when the magnetic beads are covered with silica on the surface thereof; they can be used for the purification of nucleic acids. On the other hand, when the magnetic beads are included in the Ni-NTA agarose, they can be used for the purification of oligo-histidine-proteins. Magnetic beads technology is to attract the magnetic beads by the magnetic force of magnet. Since the magnetic force is a non-contact force, the magnet can attract the magnetic beads even when they are separated by a distance or an object which does not interfere the magnetic force. Therefore, the magnetic beads technology can be applied to the plastic reaction tubes or multi-well plates/blocks, which are used frequently in the labs.

The magnetic force of a well-designed magnetic plate can act on each well of the multi-well plate/block. When applying the magnetic beads technology in experimental operation, the magnetic beads are usually suspended in the reaction liquid in many steps. It is easy to attract and fix magnetic beads to the bottom of each well by the magnetic plate disposed below the multi-well plate/block, so that the magnetic beads can be separated from the liquid. Then the liquid is removed in the later step, which is the rate-limiting step. Usually, there are two ways to remove the liquid. One is to suck out the liquid in the wells by pipets, and the other is to hold the multi-well plate/block-magnet plate by hand, and then rotate it and tap, so that the liquid can flow out. The former way can recover or discard the sucked liquid depending on the purposes, but it takes too much time or consumes too many plastic tips. The latter way can remove all the liquid at a time, but it is hard to recover the liquid. Therefore, both ways have advantages and disadvantages, and can be complementary to each other. At present, there is no apparatus to perform the manpower-like rotating and tapping actions on the program controlled workstation.

Therefore, the present invention provides a rotating and tapping apparatus to perform the manpower-like rotating and taping actions on the program controlled workstation.

### SUMMARY OF THE INVENTION

It is an object of the present invention to provide a rotating and tapping apparatus for removing liquid in a multi-well plate on a program controlled workstation.

In accordance with an aspect of the present invention, the rotating and tapping apparatus includes a frame device for holding at least a multi-well plate thereon, and a driving device for proceeding the rotating and tapping actions of the frame device to remove liquid in the multi-well plate.

### BRIEF DESCRIPTION OF THE DRAWINGS

FIG. 1 shows the rotating and tapping apparatus according to a preferred embodiment of the present invention;

FIG. 2 shows the plate holder according to a preferred embodiment of the present invention;

FIG. 3 shows the multi-well plate according to a preferred embodiment of the present invention; and

FIGS. 4-5 show the rotating process of the rotating and tapping apparatus in FIG. 1.

### DETAILED DESCRIPTION OF THE PREFERRED EMBODIMENT

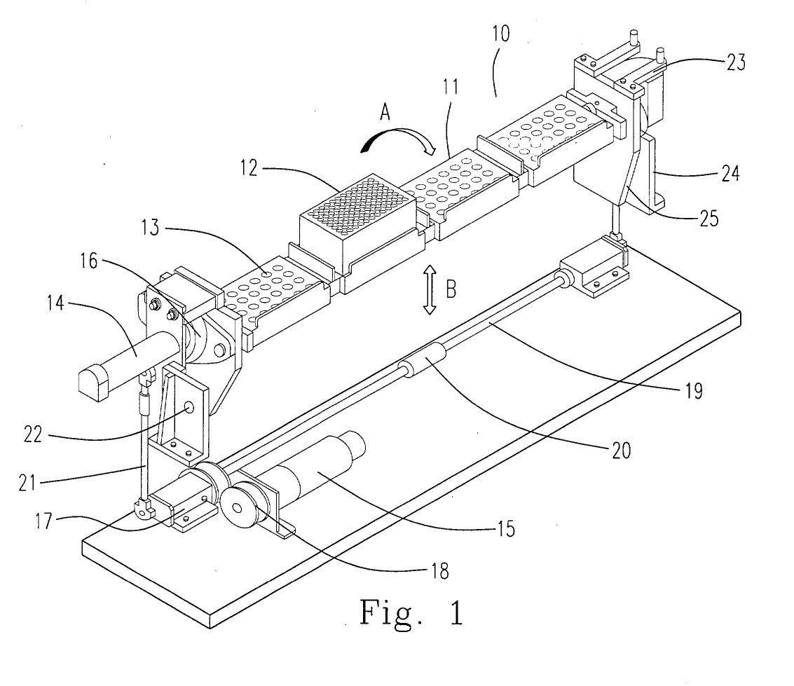

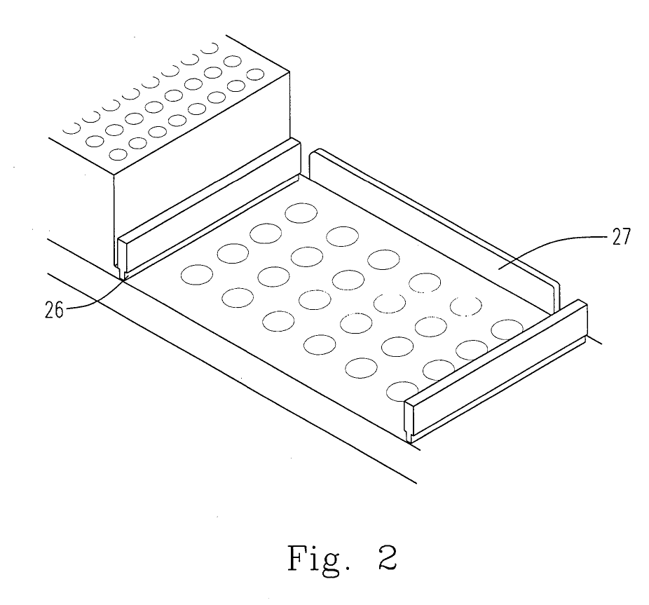

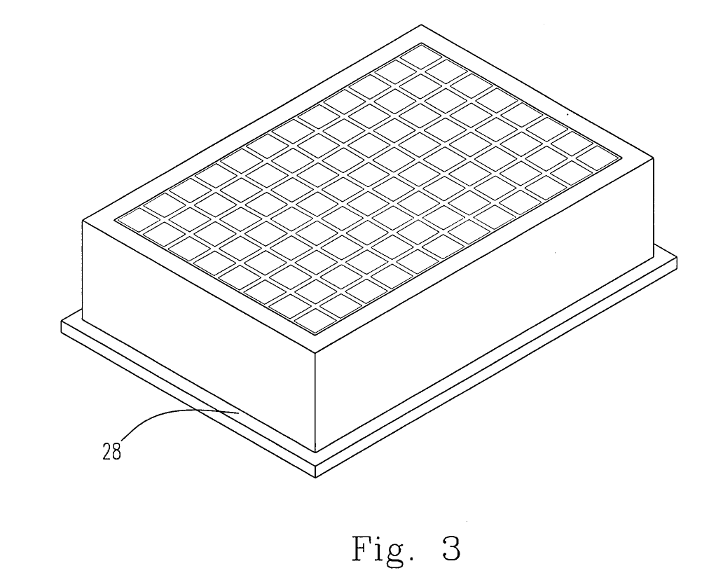

Please refer to FIG. 1 showing the rotating and tapping apparatus of the present invention. The rotating and tapping apparatus includes a frame device 10 whose actions are controlled by a driving device. The frame device 10 includes four plate holders 11 for holding multi-well plates/blocks 12 thereon. The plate holder has two slots 26 disposed at two opposite sides thereof, and a block 27 disposed at a third side thereof (as shown in FIG. 2). Since the multi-well plate/block 12 usually has additional edges 28 (as shown in FIG. 3), it can be slid into the slots 26 of the plate holder 11 and blocked by the block 27 of the plate holder 11. Therefore, the multi-well plate/block 12 can be positioned on the plate holder 11. In addition, the plate holder 11 further has 24 magnets 13, each of which corresponds to four wells when a 96-well plate/block is employed.

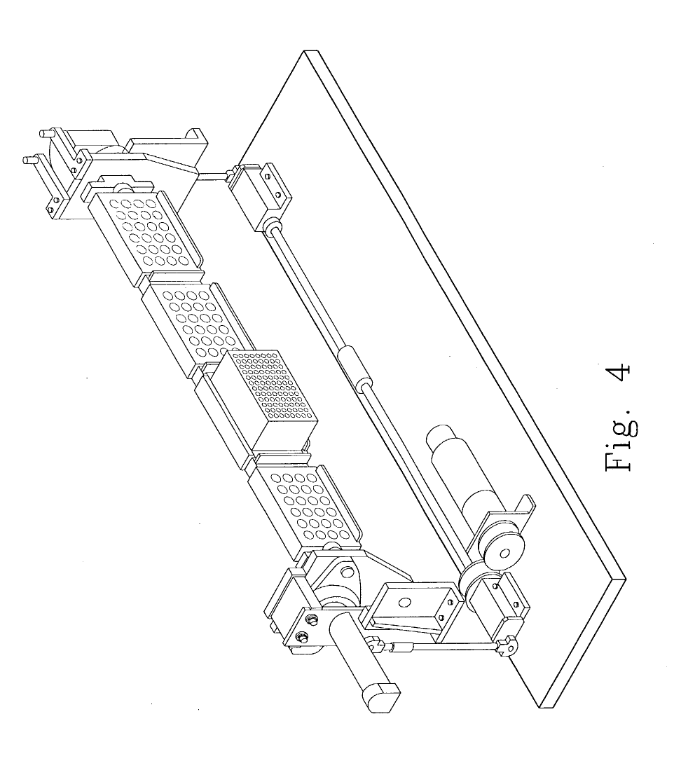

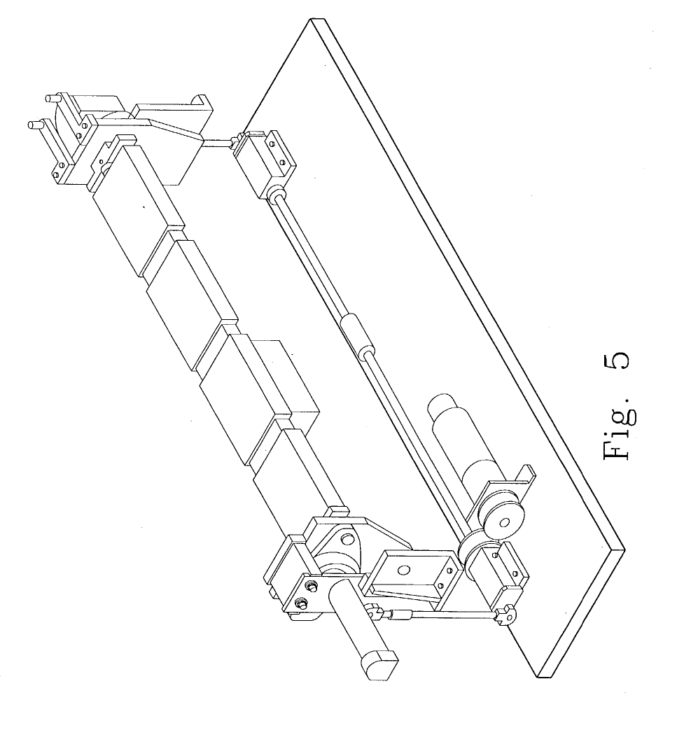

Please refer to FIG. 1 again. The driving device includes a first motor 14 and a second motor 15 for proceeding the rotating action (as indicated as arrow A) and tapping action (as indicated as arrow B) of the frame device 10, respectively. The frame device 10 is connected to the first motor 14 via a ball bearing unit 16. When the first motor 14 receives a rotating instruction of a program, it will drive its shaft (not shown), as well as the frame device 10, to be rotated (the rotating process is shown in FIGS. 1 and 4-5). When the second motor 15 receives a tapping instruction of a program, it will drive the tapping action of the frame device 10, and the working mechanism is briefly described as follows. The rotating power of the second motor 15 is transmitted to eccentric wheels 17 located at the two sides of the apparatus through a motor wheels 18, a rotating shaft 19 and a universal joint 20. Then the eccentric wheels 17 are eccentrically rotated, which drives the up and down movement of the tapping rods 21, as well as the frame device 10. In addition, a position sensor 22 can be used for detecting the vertical position of the frame device 10, and a stopper 23 can mechanically position the frame device 10 at a horizontal position. The rotating and tapping apparatus can be fixed on the workstation by blocks 24 at the two sides of the apparatus, and the frame device 10 can be fixed to the blocks 24 by block-slide guides 25 at the two sides of the apparatus, which enable the up and down movement of the frame device 10. Furthermore, a waste tank (not shown) can be provided below the frame device 10 for receiving the waste liquid.

A general operating process of the rotating and tapping apparatus of the present invention is described as follows:

1. The multi-well plate/block containing liquid and magnetic beads therein is positioned on the plate holder.

2. After a few minutes (1 min for example), the magnetic beads are attracted to the bottom of each well by the magnets of the plate holder.

3. The frame device is rotated by the first motor which is instructed by a program, so that the openings of the wells are faced down. (During the rotating process, the side of the plate holder having the block is kept at a lower position for preventing the multi-well plate/block from sliding out of the plate holder.)

4. The liquid in the wells flows out of the wells. But due to the adhesive force, a little liquid still remains on the inner walls of the wells.

5. The frame device is tapped by the second motor which is instructed by a program. For removing the residual liquid efficiently, the frame device is tapped for several times (30 times for example). In addition, the downward speed is faster than the upward speed, because if the downward speed and the upward speed are the same, the residual liquid may remain at the same position on the walls of the wells.

6. The frame device is rotated by the first motor which is instructed by a program, so that the openings of the wells are faced up as the state in the beginning.

### EXAMPLE

A program controlled workstation integrated with the rotating and tapping apparatus of the present invention can be used for high-throughput purification of plasmids from bacterial cultures.

Bacteria are cultured in a 96-well microplate, and the bacterial cells are harvested by centrifugation for 5 min at 1500×g in a centrifuge with a rotor for microplates. Then the 96-well microplate is put on the plate holder of the present invention to be rotated and then tapped for 60 times, so as to remove the cultural medium in the wells. After removing the cultural medium, the pelleted bacterial cells are proceeded with MagAttract 96 Miniprep procedure (QIAGEN). Under the optimized buffer conditions, the MagAttract suspension (containing magnetic silica beads) is added to the crude lysate, and the plasmid DNA selectively binds to the surface of the magnetic silica beads. Then, the lysate solution is removed, and the beads are washed with washing buffers for four times. Finally, 50 ul of buffer EB is added to get the plasmid eluate from the magnetic silica beads. In brief, the rotating and tapping apparatus on the program controlled workstation is respectively used to remove the cultural medium, lysate solution, and four washing buffers in the procedure of QIAGEN MagAttract 96 Miniprep kit, and it has the following advantages:

(1) It may save 6 tips per preparation for the steps to remove the cultural medium, lysate solution, and four washing buffers. Thus, the cost can be significantly reduced and the environment is less contaminated for high-throughput applications, such as billions preparations of DNA sequencing.

(2) It increases the system capacity for microplates. For example, if the frame device includes four plate holders, 4×96 samples can be processed at the same time.

(3) It increases the purification speed. According to the preferred embodiment of the present invention, 4×96 samples can be purified in 1.5 hours, i.e. about 14 sec per preparation, while using a general workstation, it may take double or triple time for this kit.

(4) It allows fully automatic high-throughput sample purification.

Therefore, the present invention exhibits industrial application and high commercial value.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A rotating and tapping apparatus, comprising:
a frame device having at least a plate holder for holding at least a multi-well plate thereon; and
a driving device for controlling and proceeding a rotating and a tapping actions of said frame device to remove liquid in said multi-well plate.

2. The apparatus according to claim 1 wherein said rotating and tapping apparatus is integrated into a program controlled workstation.

3. The apparatus according to claim 1 wherein said plate holder has two slots disposed at two opposite sides thereof for said multi-well plate to slide thereinto.

4. The apparatus according to claim 1 wherein said plate holder has a block for positioning said multi-well plate.

5. The apparatus according to claim 1 wherein said plate holder has plural magnets for attracting magnetic beads in said multi-well plate.

6. The apparatus according to claim 1 wherein said driving device comprises a first motor and a second motor.

7. The apparatus according to claim 6 wherein said first motor controls said rotating action of said frame device.

8. The apparatus according to claim 6 wherein said second motor controls said tapping action of said frame device.

9. The apparatus according to claim 8 wherein said tapping action has a relatively faster downward and a relatively slower upward movements.

10. The apparatus according to claim 1 further comprising a waste tank for receiving said liquid removed from said multi-well plate.
